(19) United States
(12) Patent Application Publication
(10) Pub. No.: US 2026/0264716 A1
(43) Pub. Date: Sep. 10, 2026

(54) VEHICLE DRIVING ASSISTANCE APPARATUS, VEHICLE DRIVING ASSISTANCE METHOD, AND STORAGE MEDIUM STORING VEHICLE DRIVING ASSISTANCE PROGRAM

(71) Applicants: TOYOTA JIDOSHA KABUSHIKI KAISHA, Toyota-shi (JP); DENSO CORPORATION, Kariya-city (JP)

(72) Inventors: Hideki Kamatani, Toyota-shi (JP); Hirotada Otake, Susono-shi (JP); Hiroki Terashita, Susono-shi (JP)

(73) Assignees: TOYOTA JIDOSHA KABUSHIKI KAISHA, Toyota-shi (JP); DENSO CORPORATION, Kariya-city (JP)

(21) Appl. No.: 19/441,962

(22) Filed: Jan. 7, 2026

(30) Foreign Application Priority Data
Mar. 7, 2025 (JP) 2025-036292

(51) Int. Cl. B60W 60/00; B60W 30/18

(52) U.S. Cl. CPC B60W 60/001; B60W 30/18072; B60W 2510/10; B60W 2510/18; B60W 2554/4041; B60W 2554/802; B60W 2720/10; B60W 2754/30

(57) ABSTRACT

A vehicle driving assistance apparatus executes an autonomous driving control of autonomously driving a host vehicle. The autonomous driving control includes an intermittent driving control of driving the host vehicle by autonomously and alternately executing a propelling control and a coasting control such that a traveling speed of the host vehicle falls within a predetermined speed range or such that an inter-vehicle distance falls within a predetermined distance range. The vehicle driving assistance apparatus does not execute the intermittent driving control when a shift operation device is set to a manual position. The manual position is a shift position in which an operator of the host vehicle manually changes a gear ratio of a transmission.

### CROSS-REFERENCE TO RELATED APPLICATIONS

This application claims priority to Japanese patent application No. JP 2025-036292 filed on March 7, 2025, the content of which is hereby incorporated by reference in its entirety.

### BACKGROUND

### Field

The present invention relates to a vehicle driving assistance apparatus, a vehicle driving assistance method, and a storage medium storing a vehicle driving assistance program.

### Description of the Related Art

There is known a vehicle driving assistance apparatus which executes an autonomous driving control (hereinafter, “intermittent driving control”) of driving a host vehicle by autonomously and alternately executing a propelling control of propelling the host vehicle by a driving force and a coasting control of causing the host vehicle to coast such that a traveling speed of the host vehicle falls within a predetermined speed range or such that an inter-vehicle distance between the host vehicle and a preceding vehicle falls within a predetermined distance range. The vehicle driving assistance apparatus aims to reduce the amount of consumed energy by executing the intermittent driving control. It should be noted that the amount of consumed energy is an amount of energy consumed by a driving apparatus to drive the host vehicle.

Further, there is also known a vehicle driving assistance apparatus which adopts, as a condition for executing the coasting control, a condition that a shift position is a drive position or a manual position (for example, refer to Japanese Unexamined Patent Publication No. 2017-223154).

Meanwhile, when the shift position is set to the manual position, a gear ratio is changed according to an intention of a driver of the host vehicle. Therefore, in a situation where the shift position is set to the manual position, when the intermittent driving control is executed, there is a possibility that the amount of consumed energy increases.

### SUMMARY

An object of the present invention is to provide a vehicle driving assistance apparatus, a vehicle driving assistance method, and a storage medium storing a vehicle driving assistance program capable of more reliably reducing the amount of consumed energy.

A vehicle driving assistance apparatus according to the present invention comprises an electronic control unit configured to execute an autonomous driving control of autonomously driving a host vehicle. The autonomous driving control includes an intermittent driving control. The intermittent driving control is a control of driving the host vehicle by autonomously and alternately executing a propelling control of propelling the host vehicle by a driving force and a coasting control of causing the host vehicle to coast such that a traveling speed of the host vehicle falls within a predetermined speed range in a situation where a preceding vehicle does not exist, and by autonomously and alternately executing the propelling control and the coasting control such that an inter-vehicle distance between the host vehicle and the preceding vehicle falls within a predetermined distance range in a situation where the preceding vehicle exists. The electronic control unit is configured not to execute the intermittent driving control when a shift operation device of the host vehicle is set to a manual position. The manual position is a shift position in which an operator of the host vehicle manually changes a gear ratio of a transmission of the host vehicle.

When the shift operation device is set to the manual position, the gear ratio is changed according to an intention of an operator of the host vehicle. Therefore, in a situation where the shift operation device is set to the manual position, when the intermittent driving control of autonomously executing the propelling control and the coasting control is executed, there is a possibility that the amount of consumed energy increases.

According to the vehicle driving assistance apparatus of the present invention, when the shift operation device is set to the manual position, the intermittent driving control is not executed. Therefore, it is possible to suppress an increase in the amount of consumed energy. Accordingly, it is possible to more reliably reduce the amount of consumed energy.

In the vehicle driving assistance apparatus according to an aspect of the present invention, the intermittent driving control may be tuned on the premise that the shift operation device is set to a drive position. In this aspect, the drive position may be a shift position in which the gear ratio is automatically changed.

In a case where the intermittent driving control is tuned on the premise that the shift operation device is set to the drive position, in a situation where the shift operation device is set to a shift position other than the drive position, when the intermittent driving control is executed, there is a possibility that the amount of consumed energy increases.

According to the vehicle driving assistance apparatus of this aspect of the present invention, when the shift operation device is set to the manual position which is not the drive position, the intermittent driving control is not executed. Therefore, it is possible to suppress an increase in the amount of consumed energy. Accordingly, it is possible to more reliably reduce the amount of consumed energy.

Further, in the vehicle driving assistance apparatus according to another aspect of the present invention, the electronic control unit may be configured not to execute the intermittent driving control when the shift operation device is set to a brake position. In this aspect, the brake position may be a shift position in which the gear ratio is automatically changed with a predetermined shift characteristic. Further, when the shift operation device is set to the brake position, the gear ratio may be set such that a deceleration rate of the host vehicle becomes greater than the deceleration rate when the shift operation device is set to the drive position. Furthermore, the drive position may be a shift position in which the gear ratio is automatically changed with a shift characteristic different from the predetermined shift characteristic.

In a case where the shift characteristic is a characteristic in which a deceleration rate of the host vehicle is made relatively great, when the intermittent driving control of autonomously executing the propelling control and the coasting control is executed, there is a possibility that the amount of consumed energy increases.

According to the vehicle driving assistance apparatus of this aspect of the present invention, when the shift operation device is set to the brake position in which the shift characteristic is a characteristic in which a deceleration rate of the host vehicle is made relatively great, the intermittent driving control is not executed. Therefore, it is possible to suppress an increase in the amount of consumed energy. Accordingly, it is possible to more reliably reduce the amount of consumed energy.

Furthermore, in the vehicle driving assistance apparatus according to further another aspect of the present invention, the electronic control unit may be configured not to execute the intermittent driving control when it is predicted that an amount of consumed energy becomes equal to or more than a predetermined energy amount. In this aspect, the amount of consumed energy may be an amount of energy consumed to drive the host vehicle when the shift operation device is set to the brake position and the intermittent driving control is performed while the shift operation device is set to the brake position. Further, the brake position may be a shift position in which the gear ratio is automatically changed with a predetermined shift characteristic.

In a situation where the shift operation device is set to the brake position, when the intermittent driving control is executed, and an amount of energy consumed for driving the host vehicle becomes large, it is not preferable that the intermittent driving control is executed.

According to the vehicle driving assistance apparatus of this aspect of the present invention, in a situation where the shift operation device is set to the brake position, when it is predicted that an amount of energy consumed for driving the host vehicle becomes equal to or more than the predetermined energy amount in a case where the intermittent driving control is executed, the intermittent driving control is not executed. Therefore, it is possible to suppress an increase in the amount of consumed energy. Accordingly, it is possible to more reliably reduce the amount of consumed energy.

Furthermore, in the vehicle driving assistance apparatus according to further another aspect of the present invention, the electronic control unit may be configured to not execute the intermittent driving control when the execution of the intermittent driving control is requested and the shift operation device is set to the manual position, and stop the intermittent driving control when the shift operation device is set to the manual position while the intermittent driving control is executed.

According to the vehicle driving assistance apparatus of this aspect of the present invention, in a situation where the shift operation device is set to the manual position, even when the execution of the intermittent driving control is requested, the intermittent driving control is not executed. Further, in a situation where the shift operation device is set to the manual position during the execution of the intermittent driving control, the intermittent driving control is stopped. Therefore, it is possible to suppress an increase in the amount of consumed energy. Accordingly, it is possible to more reliably reduce the amount of consumed energy.

Furthermore, a vehicle driving assistance method according to the present invention is a method for executing an autonomous driving control of autonomously driving a host vehicle. The autonomous driving control includes an intermittent driving control. The intermittent driving control is a control of driving the host vehicle by autonomously and alternately executing a propelling control of propelling the host vehicle by a driving force and a coasting control of causing the host vehicle to coast such that a traveling speed of the host vehicle falls within a predetermined speed range in a situation where a preceding vehicle does not exist, and by autonomously and alternately executing the propelling control and the coasting control such that an inter-vehicle distance between the host vehicle and the preceding vehicle falls within a predetermined distance range in a situation where the preceding vehicle exists. The method includes a step of not executing the intermittent driving control when a shift operation device of the host vehicle is set to a manual position. The manual position is a shift position in which an operator of the host vehicle manually changes a gear ratio of a transmission of the host vehicle.

According to the vehicle driving assistance method of the present invention, for the same reason as described above, it is possible to more reliably reduce the amount of consumed energy.

Furthermore, a computer-readable storage medium according to the present invention stores a vehicle driving assistance program of executing an autonomous driving control of autonomously driving a host vehicle. The autonomous driving control includes an intermittent driving control. The intermittent driving control is a control of driving the host vehicle by autonomously and alternately executing a propelling control of propelling the host vehicle by a driving force and a coasting control of causing the host vehicle to coast such that a traveling speed of the host vehicle falls within a predetermined speed range in a situation where a preceding vehicle does not exist, and by autonomously and alternately executing the propelling control and the coasting control such that an inter-vehicle distance between the host vehicle and the preceding vehicle falls within a predetermined distance range in a situation where the preceding vehicle exists. The vehicle driving assistance program is configured not to execute the intermittent driving control when a shift operation device of the host vehicle is set to a manual position. The manual position is a shift position in which an operator of the host vehicle manually changes a gear ratio of a transmission of the host vehicle.

According to the vehicle driving assistance program of the present invention, for the same reason as described above, it is possible to more reliably reduce the amount of consumed energy.

Constituent elements of the present invention are not limited to embodiments of the present invention described later with reference to the drawings. Other objects, other features, and associated advantages of the present invention will be easily understood from the description of embodiments of the present invention.

### BRIEF DESCRIPTION OF THE DRAWINGS

FIG. 1 is a diagram showing a vehicle driving assistance apparatus according to an embodiment of the present invention.

FIG. 2 is a diagram showing a situation in which a preceding vehicle exists.

FIG. 3 is a flowchart showing a routine executed by the vehicle driving assistance apparatus according to the embodiment of the present invention.

FIG. 4 is a flowchart showing a routine executed by the vehicle driving assistance apparatus according to the embodiment of the present invention.

FIG. 5 is a flowchart showing a routine executed by the vehicle driving assistance apparatus according to the embodiment of the present invention.

### DETAILED DESCRIPTION

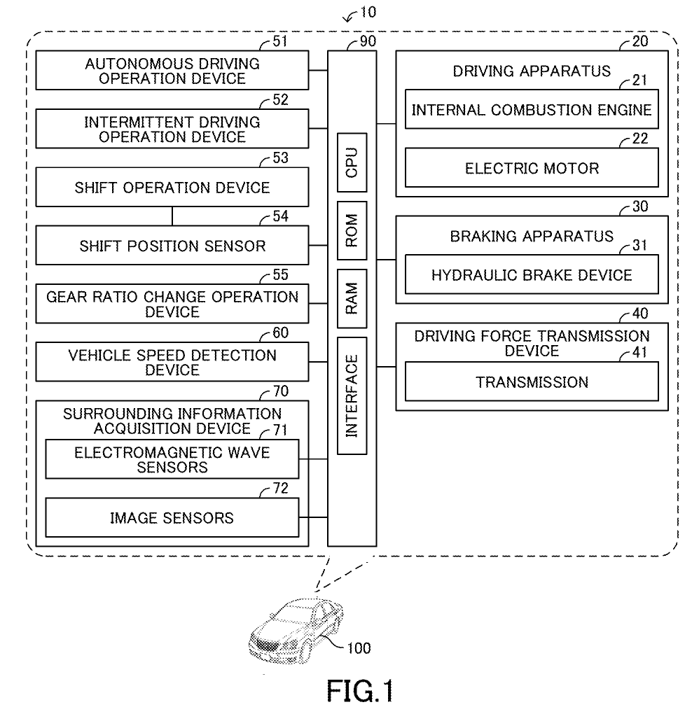

Hereinafter, a vehicle driving assistance apparatus, a vehicle driving assistance method, and a storage medium storing a vehicle driving assistance program according to an embodiment of the present invention will be described with reference to the drawings. As shown in FIG. 1, a vehicle driving assistance apparatus 10 according to the embodiment of the present invention is illustrated. The vehicle driving assistance apparatus 10 is mounted on a host vehicle 100. Hereinafter, the vehicle driving assistance apparatus 10 will be described by taking, as an example, a case where an operator or a user of the host vehicle 100 is a driver of the host vehicle 100 (that is, a person who boards the host vehicle 100 and drives the host vehicle 100). However, the operator or the user of the host vehicle 100 may be a remote operator of the host vehicle 100 (that is, a person who drives the host vehicle 100 remotely without boarding the host vehicle 100). It should be noted that, in the following description, the driver of the host vehicle 100 may simply be referred to as “the driver.”

As shown in FIG. 1, the vehicle driving assistance apparatus 10 includes an ECU (electronic control unit) 90 serving as a control device. The ECU 90 includes a microcomputer as a main component. The microcomputer includes a CPU, a computer-readable storage medium, and an interface or the like. The storage medium includes a ROM, a RAM, and a non-volatile memory or the like. The CPU is configured to realize various functions by executing instructions, programs, or routines stored in the storage medium. In particular, in this example, the vehicle driving assistance apparatus 10 stores, in the storage medium, programs for realizing various controls executed by the vehicle driving assistance apparatus 10.

It should be noted that, in this example, the vehicle driving assistance apparatus 10 includes only one ECU 90, but may include a plurality of ECUs and be configured such that functions of the vehicle driving assistance apparatus 10 described below are shared and performed by the respective ECUs.

Further, the vehicle driving assistance apparatus 10 may be configured such that the programs stored in the storage medium can be updated (i.e., upgraded) through wireless communication (for example, Internet communication) with external devices.

Further, the vehicle driving assistance apparatus 10 can be applied not only to a vehicle which is driven by manual driving by an operator, but also to a vehicle which is driven by automatic driving.

As shown in FIG. 1, the host vehicle 100 is provided with a driving apparatus 20, a braking apparatus 30, and a driving force transmission device 40.

The driving apparatus 20 generates a driving force to be applied to the host vehicle 100 (in particular, to driven wheels of the host vehicle 100). In this example, the driving apparatus 20 includes an internal combustion engine 21 and at least one electric motor 22. The driving apparatus 20 is electrically connected to the ECU 90. The vehicle driving assistance apparatus 10 controls the driving force applied to the host vehicle 100 by controlling the operation of the driving apparatus 20 (that is, the internal combustion engine 21 and the electric motor 22).

The braking apparatus 30 applies a braking force to the host vehicle 100 (in particular, to wheels of the host vehicle 100). In this example, the braking apparatus 30 includes a hydraulic brake device 31. The braking apparatus 30 is electrically connected to the ECU 90. The vehicle driving assistance apparatus 10 controls the braking force applied to the host vehicle 100 by controlling the operation of the braking apparatus 30 (more specifically, the operation of the hydraulic brake device 31).

The driving force transmission device 40 transmits the driving force output from the driving apparatus 20 to the driven wheels of the host vehicle 100. In this example, the driving force transmission device 40 includes a transmission 41. The driving force transmission device 40 is electrically connected to the ECU 90.

The vehicle driving assistance apparatus 10 changes or sets a gear ratio in the transmission 41 by controlling the operation of the driving force transmission device 40.

Further, the vehicle driving assistance apparatus 10 establishes a driving force transmission path by controlling the operation of the driving force transmission device 40 such that the driving force output from the driving apparatus 20 is transmitted to the driven wheels of the host vehicle 100. The driving force transmission path is a path for transmitting the driving force from the driving apparatus 20 to the driven wheels of the host vehicle 100. On the other hand, the vehicle driving assistance apparatus 10 also blocks the driving force transmission path by controlling the operation of the driving force transmission device 40 such that the driving force from the driving apparatus 20 is not transmitted to the driven wheels of the host vehicle 100.

Furthermore, the host vehicle 100 is provided with an autonomous driving operation device 51, an intermittent driving operation device 52, a shift operation device 53, a shift position sensor 54, a gear ratio change operation device 55, a vehicle speed detection device 60, and a surrounding information acquisition device 70.

The autonomous driving operation device 51 operated by the driver. The driver requests the execution or stop of an autonomous driving control described later by operating the autonomous driving operation device 51. The autonomous driving operation device 51 is electrically connected to the ECU 90.

In a situation where the autonomous driving control is not executed, when the autonomous driving operation device 51 is operated, the vehicle driving assistance apparatus 10 determines that the execution of the autonomous driving control is requested. On the other hand, in a situation where the autonomous driving control is executed, when the autonomous driving operation device 51 is operated, the vehicle driving assistance apparatus 10 determines that the stop of the autonomous driving control is requested.

The intermittent driving operation device 52 is also operated by the driver. The driver requests the execution or stop of an intermittent driving control described later by operating the intermittent driving operation device 52. The intermittent driving operation device 52 is electrically connected to the ECU 90.

In a situation where the execution of the autonomous driving control is requested but the intermittent driving control is not executed, when the intermittent driving operation device 52 is operated, the vehicle driving assistance apparatus 10 determines that the execution of the intermittent driving control is requested. On the other hand, in a situation where the intermittent driving control is executed, when the intermittent driving operation device 52 is operated, the vehicle driving assistance apparatus 10 determines that the stop of the intermittent driving control is requested and that the execution of a steady driving control described later is requested.

The shift operation device 53 is also operated by the driver. The shift operation device 53 is, for example, a shift lever. The driver sets a shift position P of the host vehicle 100 by operating the shift operation device 53. In this example, as shift positions P, a drive position Pd, a brake position Pb (or a low position), a sport position Ps (or a second position), a manual position Pm, a neutral position Pn, a reverse position Pr, and a parking position Pp are prepared.

The drive position Pd is a shift position P for propelling the host vehicle 100 forward by applying the driving force from the driving apparatus 20 to the driven wheels of the host vehicle 100, and it is a shift position P that automatically changes the gear ratio in the transmission 41 based on a vehicle speed V1 and a required torque TQreq. The required torque TQreq is a torque requested as the torque output from the driving apparatus 20.

The brake position Pb, similarly to the drive position Pd, is a shift position P for propelling the host vehicle 100 forward by applying the driving force from the driving apparatus 20 to the driven wheels of the host vehicle 100, and it is a shift position P which automatically changes the gear ratio in the transmission 41 based on the vehicle speed V1 and the required torque TQreq. However, a shift characteristic in the brake position Pb is different from a shift characteristic in the drive position Pd. The shift characteristic is a characteristic related to a gear ratio depending on the vehicle speed V1 and the required torque TQreq.

Specifically, when the shift operation device 53 is set to the brake position Pb, the gear ratio in the transmission 41 is set such that a realized acceleration rate Ga becomes greater than a realized acceleration rate Ga in the drive position Pd. Here, the realized acceleration rate Ga is an acceleration rate of the host vehicle 100 realized when the driving force applied to the driven wheels of the host vehicle 100 is increased by a predetermined value under the same environment and vehicle speed V1 in which the host vehicle 100 travels.

Further, when the shift operation device 53 is set to the brake position Pb, the gear ratio in the transmission 41 is set such that a realized deceleration rate Gd becomes greater than a realized deceleration rate Gd in the drive position Pd. Here, the realized deceleration rate Gd is a deceleration rate of the host vehicle 100 realized when the driving force applied to the driven wheels of the host vehicle 100 is decreased by a predetermined value under the same environment and vehicle speed V1 in which the host vehicle 100 travels.

The sport position Ps, similarly to the drive position Pd and the brake position Pb, is a shift position P for propelling the host vehicle 100 forward by applying the driving force from the driving apparatus 20 to the driven wheels of the host vehicle 100, and it is a shift position P which automatically changes the gear ratio in the transmission 41 based on the vehicle speed V1 and the required torque TQreq. However, the shift characteristic in the sport position Ps is different from the shift characteristics in the drive position Pd and the brake position Pb.

Specifically, when the shift operation device 53 is set to the sport position Ps, the gear ratio in the transmission 41 is set such that a realized acceleration rate Ga becomes greater than the realized acceleration rate Ga in the drive position Pd and smaller than the realized acceleration rate Ga in the brake position Pb. Further, when the shift operation device 53 is set to the sport position Ps, the gear ratio in the transmission 41 is set such that a realized deceleration rate Gd becomes greater than the realized deceleration rate Gd in the drive position Pd and smaller than the realized deceleration rate Gd in the brake position Pb.

The manual position Pm, similarly to the drive position Pd, the brake position Pb, and the sport position Ps, is a shift position P for propelling the host vehicle 100 forward by applying the driving force from the driving apparatus 20 to the driven wheels of the host vehicle 100. However, the manual position Pm is a shift position P in which the driver manually changes the gear ratio of the transmission 41. Therefore, when the shift operation device 53 is set to the manual position Pm, the driver operates the gear ratio change operation device 55 to change the gear ratio in the transmission 41.

The neutral position Pn is a shift position P which cuts off the transmission of the driving force from the driving apparatus 20 to the driven wheels of the host vehicle 100.

The reverse position Pr is a shift position P for propelling the host vehicle 100 backward by applying the driving force from the driving apparatus 20 to the driven wheels of the host vehicle 100.

The parking position Pp is a shift position P which cuts off the transmission of the driving force from the driving apparatus 20 to the driven wheels of the host vehicle 100, and it is a shift position P in which the wheels of the host vehicle 100 are locked so as not to rotate.

The shift position sensor 54 is used for detecting the shift position P set by the shift operation device 53. The shift position sensor 54 is electrically connected to the ECU 90. The vehicle driving assistance apparatus 10 acquires the shift position P by means of the shift position sensor 54.

The gear ratio change operation device 55 is also operated by the driver. The driver changes or sets the gear ratio in the transmission 41 by operating the gear ratio change operation device 55 when the shift operation device 53 is set to the manual position Pm. The gear ratio change operation device 55 is electrically connected to the ECU 90. When the shift operation device 53 is set to the manual position Pm, the vehicle driving assistance apparatus 10 changes or sets the gear ratio in the transmission 41 according to the operation of the gear ratio change operation device 55 by the driver.

The vehicle speed detection device 60 is used for detecting the vehicle speed V1. The vehicle speed V1 is a traveling speed of the host vehicle 100. The vehicle speed detection device 60 includes, for example, wheel rotation speed sensors provided for respective wheels of the host vehicle 100. The vehicle speed detection device 60 is electrically connected to the ECU 90. The vehicle driving assistance apparatus 10 acquires the vehicle speed V1 by means of the vehicle speed detection device 60.

The surrounding information acquisition device 70 is used for detecting information on the surroundings of the host vehicle 100. In this example, the surrounding information acquisition device 70 includes a plurality of electromagnetic wave sensors 71 and a plurality of image sensors 72.

The electromagnetic wave sensors 71 are electrically connected to the ECU 90. The electromagnetic wave sensor 71 is, for example, a radar sensor such as a millimeter wave radar. The vehicle driving assistance apparatus 10 acquires, as surrounding information IS, information (object information IO) on objects existing around the host vehicle 100 by means of the electromagnetic wave sensors 71. In particular, the object information IO includes information on a preceding vehicle 200.

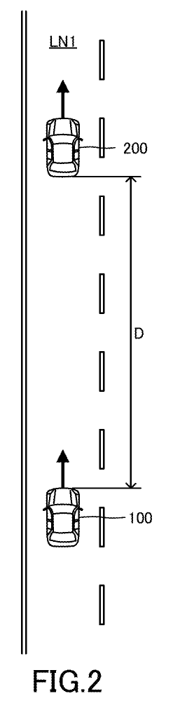

As shown in FIG. 2, the preceding vehicle 200 is another vehicle traveling on a host traveling lane LN1 and existing within a predetermined distance Dp ahead of the host vehicle 100. The host traveling lane LN1 is a lane in which the host vehicle 100 travels.

The image sensors 72 are electrically connected to the ECU 90. The image sensor 72 is, for example, a camera sensor. The vehicle driving assistance apparatus 10 acquires, as surrounding information IS, image information IC on the surroundings of the host vehicle 100 by means of the image sensors 72. In particular, the image information IC includes information on the preceding vehicle 200.

### Operation of Vehicle Driving Assistance Apparatus

Next, operation of the vehicle driving assistance apparatus 10 will be described.

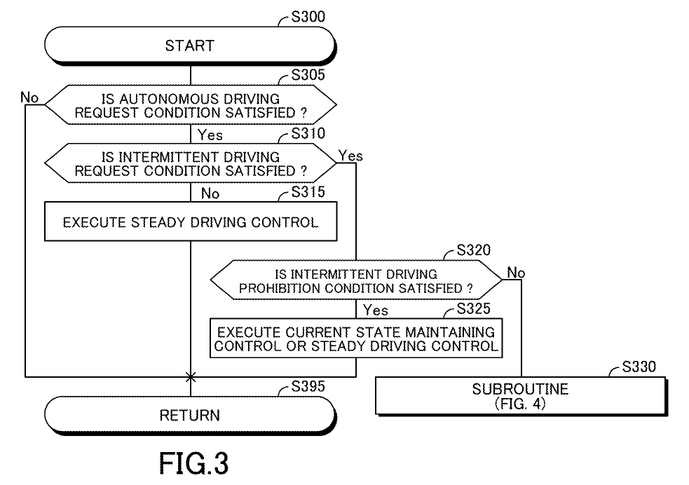

The vehicle driving assistance apparatus 10 executes an autonomous driving control when a predetermined condition is satisfied by executing, at predetermined time intervals, a routine shown in FIG. 3. The autonomous driving control autonomously drives the host vehicle 100. The autonomous driving control includes a steady driving control and an intermittent driving control.

The steady driving control includes a steady vehicle speed control and a steady inter-vehicle distance control.

When a preceding vehicle 200 exists as shown in FIG. 2, the vehicle driving assistance apparatus 10 executes the steady inter-vehicle distance control as the steady driving control. On the other hand, when the preceding vehicle 200 does not exist, the vehicle driving assistance apparatus 10 executes the steady vehicle speed control as the steady driving control. The vehicle driving assistance apparatus 10 detects the preceding vehicle 200 based on the surrounding information IS.

The steady vehicle speed control autonomously drives the host vehicle 100 by controlling operations of the driving apparatus 20 and the braking apparatus 30 such that the vehicle speed V1 is maintained at a set vehicle speed Vset. The set vehicle speed Vset is set by the driver.

On the other hand, the steady inter-vehicle distance control autonomously drives the host vehicle 100 by controlling operations of the driving apparatus 20 and the braking apparatus 30 such that an inter-vehicle distance D is maintained at a set inter-vehicle distance Dset. The inter-vehicle distance D is a distance between the host vehicle 100 and the preceding vehicle 200. The vehicle driving assistance apparatus 10 acquires the inter-vehicle distance D based on the surrounding information IS. Further, the set inter-vehicle distance Dset is set by the driver.

As described above, the steady driving control drives the host vehicle 100 by autonomously accelerating and decelerating the host vehicle 100 such that, in a situation where the preceding vehicle 200 does not exist, the vehicle speed V1 is maintained at a predetermined speed (that is, the set vehicle speed Vset), and such that, in a situation where the preceding vehicle 200 exists, the inter-vehicle distance D is maintained at a predetermined distance (that is, the set inter-vehicle distance Dset).

Further, the intermittent driving control includes an intermittent vehicle speed control and an intermittent inter-vehicle distance control.

The intermittent driving control includes a propelling control, a coasting control, and a current state maintaining control. The intermittent driving control autonomously drives the host vehicle 100 by alternately switching between the propelling control and the coasting control, unless a predetermined condition described later is satisfied.

The propelling control drives the host vehicle 100 by the driving force. In particular, in this example, the propelling control drives the host vehicle 100 by the driving force such that the host vehicle 100 is accelerated. During execution of the propelling control, the vehicle driving assistance apparatus 10 drives the host vehicle 100 by applying the driving force from the driving apparatus 20 to the host vehicle 100. It should be noted that an optimum propelling control may be adopted as the propelling control. The optimum propelling control drives the host vehicle 100 by applying the driving force from the driving apparatus 20 to the host vehicle 100 while controlling the operation of the driving apparatus 20 such that a driving energy efficiency becomes highest. It should be noted that the driving energy efficiency is an energy efficiency for generating the driving force by the driving apparatus 20.

The coasting control causes the host vehicle 100 to coast. During execution of the coasting control, the vehicle driving assistance apparatus 10 causes the host vehicle 100 to coast by stopping application of the driving force from the driving apparatus 20 to the host vehicle 100. In this example, during execution of the coasting control, the vehicle driving assistance apparatus 10 stops the application of the driving force from the driving apparatus 20 to the host vehicle 100 by cutting off the driving force transmission path. As described above, the driving force transmission path is a path for applying the driving force from the driving apparatus 20 to the host vehicle 100. The vehicle driving assistance apparatus 10 cuts off the driving force transmission path by controlling operation of the driving force transmission device 40. It should be noted that, during execution of the coasting control, the vehicle driving assistance apparatus 10 stops operation of the internal combustion engine 21.

Further, the current state maintaining control drives the host vehicle 100 by autonomously accelerating and decelerating the host vehicle 100 such that the vehicle speed V1 is maintained at the vehicle speed V1 at a start time of the current state maintaining control or such that the inter-vehicle distance D is maintained at the inter-vehicle distance D at the start time of the current state maintaining control.

It should be noted that the start time of the current state maintaining control is a time when an intermittent driving request condition C2 and an intermittent driving prohibition condition C3 described later are satisfied. Therefore, when a time at which the intermittent driving request condition C2 and the intermittent driving prohibition condition C3 are satisfied is referred to as a predetermined time, the current state maintaining control drives the host vehicle 100 by autonomously accelerating and decelerating the host vehicle 100 such that the vehicle speed V1 is maintained at the vehicle speed V1 at the predetermined time or such that the inter-vehicle distance D is maintained at the inter-vehicle distance D at the predetermined time.

In a situation where the preceding vehicle 200 exists as shown in FIG. 2, the vehicle driving assistance apparatus 10 executes the intermittent inter-vehicle distance control as the intermittent driving control. On the other hand, in a situation where the preceding vehicle 200 does not exist, the vehicle driving assistance apparatus 10 executes the intermittent vehicle speed control as the intermittent driving control. The vehicle driving assistance apparatus 10 detects the preceding vehicle 200 based on the surrounding information IS.

The intermittent vehicle speed control autonomously drives the host vehicle 100 by alternately executing the propelling control and the coasting control such that the vehicle speed V1 is maintained at a speed within a target vehicle speed range RVtgt. Accordingly, during execution of the intermittent vehicle speed control, the vehicle driving assistance apparatus 10 alternately executes the propelling control and the coasting control such that the vehicle speed V1 falls within a predetermined range (that is, the target vehicle speed range RVtgt).

During execution of the intermittent vehicle speed control, when the vehicle speed V1 increases due to execution of the propelling control and reaches an upper limit vehicle speed Vmax, the vehicle driving assistance apparatus 10 ends the propelling control and starts the coasting control. The upper limit vehicle speed Vmax is an upper limit value of the target vehicle speed range RVtgt. In this example, the set vehicle speed Vset is set as the upper limit vehicle speed Vmax (Vmax = Vset).

On the other hand, during execution of the intermittent vehicle speed control, when the vehicle speed V1 decreases due to execution of the coasting control and reaches a lower limit vehicle speed Vmin, the vehicle driving assistance apparatus 10 ends the coasting control and starts the propelling control. The lower limit vehicle speed Vmin is a lower limit value of the target vehicle speed range RVtgt. In this example, the lower limit vehicle speed Vmin is a value obtained by subtracting a target vehicle speed control width WVtgt from the set vehicle speed Vset (Vmin = Vset − WVtgt).

The intermittent inter-vehicle distance control autonomously drives the host vehicle 100 by autonomously and alternately executing the propelling control and the coasting control such that the inter-vehicle distance D is maintained at a distance within a target inter-vehicle distance range RDtgt. Accordingly, during execution of the intermittent inter-vehicle distance control, the vehicle driving assistance apparatus 10 alternately executes the propelling control and the coasting control such that the inter-vehicle distance D falls within a predetermined range (that is, the target inter-vehicle distance range RDtgt).

During execution of the intermittent inter-vehicle distance control, when the inter-vehicle distance D decreases due to execution of the propelling control and reaches a lower limit inter-vehicle distance Dmin, the vehicle driving assistance apparatus 10 ends the propelling control and starts the coasting control. The lower limit inter-vehicle distance Dmin is a lower limit value of the target inter-vehicle distance range RDtgt. In this example, the set inter-vehicle distance Dset is set as the lower limit inter-vehicle distance Dmin (Dmin = Dset).

On the other hand, during execution of the intermittent inter-vehicle distance control, when the inter-vehicle distance D increases due to execution of the coasting control and reaches an upper limit inter-vehicle distance Dmax, the vehicle driving assistance apparatus 10 ends the coasting control and starts the propelling control. The upper limit inter-vehicle distance Dmax is an upper limit value of the target inter-vehicle distance range RDtgt. In this example, the upper limit inter-vehicle distance Dmax is a value obtained by adding a target inter-vehicle distance control width WDtgt to the lower limit inter-vehicle distance Dmin (Dmax = Dmin + WDtgt).

As described above, the intermittent driving control drives the host vehicle 100 by autonomously and alternately executing the propelling control and the coasting control such that, in a situation where the preceding vehicle 200 does not exist, the vehicle speed V1 falls within a predetermined speed range (that is, the target vehicle speed range RVtgt), and such that, in a situation where the preceding vehicle 200 exists, the inter-vehicle distance D falls within a predetermined distance range (that is, the target inter-vehicle distance range RDtgt).

It should be noted that, during execution of the propelling control, when the vehicle speed V1 reaches the upper limit vehicle speed Vmax before the inter-vehicle distance D reaches the lower limit inter-vehicle distance Dmin, the vehicle driving assistance apparatus 10 stops the propelling control and executes an upper limit vehicle speed maintaining control of accelerating and decelerating the host vehicle 100 such that the vehicle speed V1 is maintained at the upper limit vehicle speed Vmax.

Further, in this example, various control parameters used in the intermittent driving control are set such that an amount of consumed energy becomes minimum within a possible range in a situation where the host vehicle 100 is driven while the shift operation device 53 is set to the drive position Pd. In other words, various control parameters used in the intermittent driving control are set such that an amount of consumed energy becomes minimum within the possible range when a shift characteristic is a shift characteristic in the drive position Pd. That is, the intermittent driving control is tuned such that an amount of consumed energy becomes minimum within the possible range in a situation where the host vehicle 100 is driven while the shift operation device 53 is set to the drive position Pd. It should be noted that the amount of consumed energy is an amount of energy consumed by the driving apparatus 20 to generate the driving force.

Here, control parameters are coefficients used in the intermittent driving control. As the control parameters, for example, the following parameters are included.

(1) The target vehicle speed control width WVtgt and the target inter-vehicle distance control width WDtgt.

(2) Sizes of hysteresis when hysteresis is provided to the upper limit vehicle speed Vmax, the lower limit vehicle speed Vmin, the upper limit inter-vehicle distance Dmax, and the lower limit inter-vehicle distance Dmin.

(3) Coefficients used in an arithmetic expression, a model, logic, or an algorithm for calculating a target driving force Ftgt.

(4) Upper and lower limit values when upper and lower limit values are provided to an acceleration rate of the host vehicle 100 during execution of the propelling control.

(5) An upper limit value (that is, a maximum jerk) when an upper limit value is provided to a jerk of the host vehicle 100 during execution of the propelling control.

(6) Gains in a PID control when the PID control is used in the intermittent driving control.

It should be noted that the target driving force Ftgt is a target value of the driving force to be output from the driving apparatus 20 during execution of the propelling control.

The vehicle driving assistance apparatus 10 starts a process from a step S300 of a routine shown in FIG. 3 at a predetermined timing. Then, the vehicle driving assistance apparatus 10 proceeds with the process to a step S305 to determine whether or not an autonomous driving request condition C1 is satisfied. The autonomous driving request condition C1 is satisfied when the execution of the autonomous driving control is requested. On the other hand, the autonomous driving request condition C1 becomes not satisfied when a stop of the autonomous driving control is requested.

When the autonomous driving request condition C1 is not satisfied, the vehicle driving assistance apparatus 10 determines “No” at the step S305, and proceeds with the process directly to a step S395 to terminate the process of this routine once. On the other hand, when the autonomous driving request condition C1 is satisfied, the vehicle driving assistance apparatus 10 determines “Yes” at the step S305, and proceeds with the process to a step S310 to determine whether or not an intermittent driving request condition C2 is satisfied. The intermittent driving request condition C2 is satisfied when the execution of the intermittent driving control is requested. On the other hand, the intermittent driving request condition C2 becomes not satisfied when a stop of the intermittent driving control is requested.

When the intermittent driving request condition C2 is not satisfied, the vehicle driving assistance apparatus 10 determines “No” at the step S310, and proceeds with the process to a step S315 to execute the steady driving control. Next, the vehicle driving assistance apparatus 10 proceeds with the process to the step S395 to terminate the process of this routine once.

On the other hand, when the intermittent driving request condition C2 is satisfied, the vehicle driving assistance apparatus 10 determines “Yes” at the step S310, and proceeds with the process to a step S320 to determine whether or not an intermittent driving prohibition condition C3 is satisfied.

The intermittent driving prohibition condition C3 is satisfied when the shift operation device 53 is not set to the drive position Pd. In other words, the intermittent driving prohibition condition C3 is satisfied when the shift operation device 53 is set to a position other than the drive position Pd. In particular, the intermittent driving prohibition condition C3 is satisfied when the shift operation device 53 is set to the manual position Pm, the brake position Pb, or the sport position Ps. That is, the intermittent driving prohibition condition C3 is satisfied when the shift operation device 53 is set to a shift position P, other than the drive position Pd, for propelling the host vehicle 100 forward.

Alternatively, the intermittent driving prohibition condition C3 is satisfied when it is predicted that an amount of consumed energy in the brake position Pb becomes equal to or more than a predetermined energy amount. Here, the amount of consumed energy in the brake position Pb is an amount of energy consumed by the driving apparatus 20 to drive the host vehicle 100 when the shift operation device 53 is set to the brake position Pb and the intermittent driving control is executed in a situation where the shift operation device 53 is set to the brake position Pb.

Further, the intermittent driving prohibition condition C3 is satisfied when it is predicted that an amount of consumed energy in the sport position Ps becomes equal to or more than a predetermined energy amount. Here, the amount of consumed energy in the sport position Ps is an amount of energy consumed by the driving apparatus 20 to drive the host vehicle 100 when the shift operation device 53 is set to the sport position Ps and the intermittent driving control is executed in a situation where the shift operation device 53 is set to the sport position Ps.

It should be noted that, as described above, in this example, the intermittent driving control is tuned on the premise that the shift operation device 53 is set to the drive position Pd. Therefore, when the shift operation device 53 is set to the brake position Pb, the vehicle driving assistance apparatus 10 predicts that an amount of consumed energy in the brake position Pb becomes equal to or more than the predetermined energy amount. Further, when the shift operation device 53 is set to the sport position Ps, the vehicle driving assistance apparatus 10 predicts that an amount of consumed energy in the sport position Ps becomes equal to or more than the predetermined energy amount.

When the intermittent driving prohibition condition C3 is satisfied, the vehicle driving assistance apparatus 10 determines “Yes” at the step S320, and proceeds with the process to a step S325 to execute the current state maintaining control. Next, the vehicle driving assistance apparatus 10 proceeds with the process to the step S395 to terminate the process of this routine once.

In this case, when the steady vehicle speed control has been executed at a time when the process advances to the step S325, operations of the driving apparatus 20 and the braking apparatus 30 are controlled such that the vehicle speed V1 is maintained at the vehicle speed V1 at that time. On the other hand, when the steady inter-vehicle distance control has been executed at a time when the process advances to the step S325, operations of the driving apparatus 20 and the braking apparatus 30 are controlled such that the inter-vehicle distance D is maintained at the inter-vehicle distance D at that time.

It should be noted that the vehicle driving assistance apparatus 10 may be configured to continue the steady driving control instead of executing the current state maintaining control when proceeding with the process to the step S325.

As described above, the vehicle driving assistance apparatus 10 is configured not to execute the intermittent driving control when the shift operation device 53 of the host vehicle 100 is set to the manual position Pm. In particular, in this example, in a situation where the shift operation device 53 of the host vehicle 100 is set to the manual position Pm, when the execution of the intermittent driving control is requested, the vehicle driving assistance apparatus 10 is configured not to execute the intermittent driving control. Furthermore, in a situation where the intermittent driving control is executed, when the shift operation device 53 is set to the manual position Pm, the vehicle driving assistance apparatus 10 is configured to stop the intermittent driving control.

Further, the vehicle driving assistance apparatus 10 is configured to execute the current state maintaining control when the intermittent driving request condition C2 and the intermittent driving prohibition condition C3 are satisfied.

Alternatively, the vehicle driving assistance apparatus 10 is configured to execute the steady driving control when the intermittent driving request condition C2 and the intermittent driving prohibition condition C3 are satisfied.

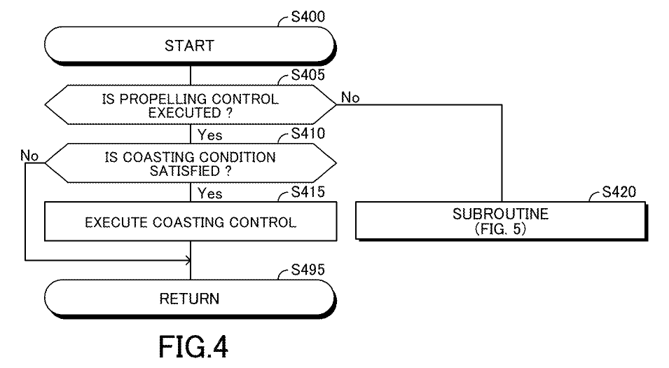

On the other hand, when the intermittent driving prohibition condition C3 is not satisfied, the vehicle driving assistance apparatus 10 determines “No” at the step S320, and proceeds with the process to a step S330 to execute a routine shown in FIG. 4. Accordingly, when the vehicle driving assistance apparatus 10 proceeds with the process to the step S330, the vehicle driving assistance apparatus 10 starts a process from a step S400 of the routine shown in FIG. 4. Then, the vehicle driving assistance apparatus 10 proceeds with the process to a step S405 to determine whether or not the propelling control is executed.

When the propelling control is executed, the vehicle driving assistance apparatus 10 determines “Yes” at the step S405, and proceeds with the process to a step S410 to determine whether or not a coasting condition C4 is satisfied. In a situation where the intermittent vehicle speed control is executed, the coasting condition C4 is satisfied when the vehicle speed V1 increases and reaches the upper limit vehicle speed Vmax. On the other hand, in a situation where the intermittent inter-vehicle distance control is executed, the coasting condition C4 is satisfied when the inter-vehicle distance D decreases and reaches the lower limit inter-vehicle distance Dmin.

When the coasting condition C4 is not satisfied, the vehicle driving assistance apparatus 10 determines “No” at the step S410, and proceeds with the process directly to a step S495 to terminate the process of this routine once. In this case, the propelling control is continued. On the other hand, when the coasting condition C4 is satisfied, the vehicle driving assistance apparatus 10 determines “Yes” at the step S410, and proceeds with the process to a step S415 to execute the coasting control. Next, the vehicle driving assistance apparatus 10 proceeds with the process to the step S495 to terminate the process of this routine once.

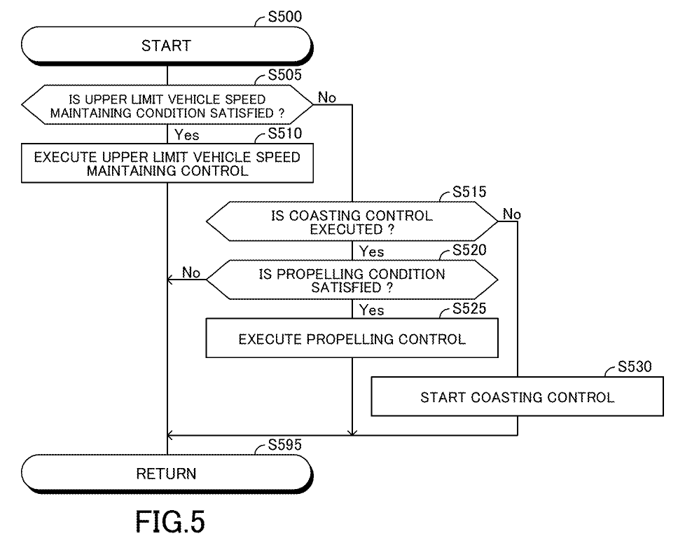

Further, when the propelling control is not executed at a time when the vehicle driving assistance apparatus 10 proceeds with the process to the step S405, the vehicle driving assistance apparatus 10 determines “No” at the step S405, and proceeds with the process to a step S420. When the vehicle driving assistance apparatus 10 proceeds with the process to the step S420, the vehicle driving assistance apparatus 10 starts a process from a step S500 of a routine shown in FIG. 5. Then, the vehicle driving assistance apparatus 10 proceeds with the process to a step S505 to determine whether or not an upper limit vehicle speed maintaining condition C5 is satisfied. The upper limit vehicle speed maintaining condition C5 is satisfied when the vehicle speed V1 increases and reaches the upper limit vehicle speed Vmax during execution of the intermittent inter-vehicle distance control.

When the upper limit vehicle speed maintaining condition C5 is satisfied, the vehicle driving assistance apparatus 10 determines “Yes” at the step S505, and proceeds with the process to a step S510 to execute the upper limit vehicle speed maintaining control. Next, the vehicle driving assistance apparatus 10 proceeds with the process to a step S595 to terminate the process of this routine once.

On the other hand, when the upper limit vehicle speed maintaining condition C5 is not satisfied, the vehicle driving assistance apparatus 10 determines “No” at the step S505, and proceeds with the process to a step S515 to determine whether or not the coasting control is executed.

When the coasting control is executed, the vehicle driving assistance apparatus 10 determines “Yes” at the step S515, and proceeds with the process to a step S520 to determine whether or not a propelling condition C6 is satisfied. In a situation where the intermittent vehicle speed control is being executed, the propelling condition C6 is satisfied when the vehicle speed V1 decreases and reaches the lower limit vehicle speed Vmin. On the other hand, in a situation where the intermittent inter-vehicle distance control is being executed, the propelling condition C6 is satisfied when the inter-vehicle distance D increases and reaches the upper limit inter-vehicle distance Dmax.

When the propelling condition C6 is not satisfied, the vehicle driving assistance apparatus 10 determines “No” at the step S520, and proceeds with the process directly to the step S595 to terminate the process of this routine once. In this case, the coasting control is continued. On the other hand, when the propelling condition C6 is satisfied, the vehicle driving assistance apparatus 10 determines “Yes” at the step S520, and proceeds with the process to a step S525 to execute the propelling control. Next, the vehicle driving assistance apparatus 10 proceeds with the process to the step S595 to terminate the process of this routine once.

Further, when the coasting control is not executed at a time when the vehicle driving assistance apparatus 10 proceeds with the process to the step S515, the vehicle driving assistance apparatus 10 determines “No” at the step S515, and proceeds with the process to a step S530 to start the coasting control. Next, the vehicle driving assistance apparatus 10 proceeds with the process to the step S595 to terminate the process of this routine once.

It should be noted that a situation where the vehicle driving assistance apparatus 10 determines “No” at the step S515 is a situation in which, after the execution of the intermittent driving control is requested, the vehicle driving assistance apparatus 10 determines “No” for the first time at the step S320 of the routine shown in FIG. 3. In this situation, since neither the propelling control nor the coasting control has been started, the vehicle driving assistance apparatus 10 determines “No” at the step S515.

Further, when the vehicle driving assistance apparatus 10 proceeds with the process to the step S530, the vehicle driving assistance apparatus 10 may be configured to start the propelling control instead of starting the coasting control.

The above is the operation of the vehicle driving assistance apparatus 10.

When the shift operation device 53 is set to the manual position Pm, the brake position Pb, or the sport position Ps, the gear ratio in the transmission 41 is changed according to an intention of the driver of the host vehicle 100. Therefore, in a situation where the shift operation device 53 is set to the manual position Pm, the brake position Pb, or the sport position Ps, when the intermittent driving control of autonomously executing the propelling control and the coasting control is executed, there is a possibility that an amount of consumed energy increases.

According to the vehicle driving assistance apparatus 10, when the shift operation device 53 is set to the manual position Pm, the brake position Pb, or the sport position Ps, the intermittent driving control is not executed. Therefore, it is possible to suppress an increase in the amount of consumed energy. Accordingly, it is possible to more reliably reduce the amount of consumed energy.

It should be noted that the present invention is not limited to the above-described embodiment, and various modified examples can be adopted within the scope of the present invention.

What is claimed is:

1. A vehicle driving assistance apparatus comprising an electronic control unit configured to execute an autonomous driving control of autonomously driving a host vehicle,
wherein the autonomous driving control includes an intermittent driving control,
wherein the intermittent driving control is a control of driving the host vehicle by autonomously and alternately executing a propelling control of propelling the host vehicle by a driving force and a coasting control of causing the host vehicle to coast such that a traveling speed of the host vehicle falls within a predetermined speed range in a situation where a preceding vehicle does not exist, and by autonomously and alternately executing the propelling control and the coasting control such that an inter-vehicle distance between the host vehicle and the preceding vehicle falls within a predetermined distance range in a situation where the preceding vehicle exists,
wherein the electronic control unit is configured not to execute the intermittent driving control when a shift operation device of the host vehicle is set to a manual position, and
wherein the manual position is a shift position in which an operator of the host vehicle manually changes a gear ratio of a transmission of the host vehicle.

2. The vehicle driving assistance apparatus according to claim 1,
wherein the intermittent driving control is tuned on the premise that the shift operation device is set to a drive position, and
wherein the drive position is a shift position in which the gear ratio is automatically changed.

3. The vehicle driving assistance apparatus according to claim 1,
wherein the electronic control unit is configured not to execute the intermittent driving control when the shift operation device is set to a brake position,
wherein the brake position is a shift position in which the gear ratio is automatically changed with a predetermined shift characteristic,
wherein, when the shift operation device is set to the brake position, the gear ratio is set such that a deceleration rate of the host vehicle becomes greater than the deceleration rate when the shift operation device is set to the drive position, and
wherein the drive position is a shift position in which the gear ratio is automatically changed with a shift characteristic different from the predetermined shift characteristic.

4. The vehicle driving assistance apparatus according to claim 1,
wherein the electronic control unit is configured not to execute the intermittent driving control when it is predicted that an amount of consumed energy becomes equal to or more than a predetermined energy amount,
wherein the amount of consumed energy is an amount of energy consumed to drive the host vehicle when the shift operation device is set to the brake position and the intermittent driving control is performed while the shift operation device is set to the brake position, and
wherein the brake position is a shift position in which the gear ratio is automatically changed with a predetermined shift characteristic.

5. The vehicle driving assistance apparatus according to claim 1,
wherein the electronic control unit is configured to:
not execute the intermittent driving control when the execution of the intermittent driving control is requested and the shift operation device is set to the manual position; and
stop the intermittent driving control when the shift operation device is set to the manual position while the intermittent driving control is executed.

6. A vehicle driving assistance method for executing an autonomous driving control of autonomously driving a host vehicle,
wherein the autonomous driving control includes an intermittent driving control,
wherein the intermittent driving control is a control of driving the host vehicle by autonomously and alternately executing a propelling control of propelling the host vehicle by a driving force and a coasting control of causing the host vehicle to coast such that a traveling speed of the host vehicle falls within a predetermined speed range in a situation where a preceding vehicle does not exist, and by autonomously and alternately executing the propelling control and the coasting control such that an inter-vehicle distance between the host vehicle and the preceding vehicle falls within a predetermined distance range in a situation where the preceding vehicle exists,
wherein the method includes a step of not executing the intermittent driving control when a shift operation device of the host vehicle is set to a manual position, and
wherein the manual position is a shift position in which an operator of the host vehicle manually changes a gear ratio of a transmission of the host vehicle.

7. A computer-readable storage medium storing a vehicle driving assistance program of executing an autonomous driving control of autonomously driving a host vehicle,
wherein the autonomous driving control includes an intermittent driving control,
wherein the intermittent driving control is a control of driving the host vehicle by autonomously and alternately executing a propelling control of propelling the host vehicle by a driving force and a coasting control of causing the host vehicle to coast such that a traveling speed of the host vehicle falls within a predetermined speed range in a situation where a preceding vehicle does not exist, and by autonomously and alternately executing the propelling control and the coasting control such that an inter-vehicle distance between the host vehicle and the preceding vehicle falls within a predetermined distance range in a situation where the preceding vehicle exists,
wherein the vehicle driving assistance program is configured not to execute the intermittent driving control when a shift operation device of the host vehicle is set to a manual position, and
wherein the manual position is a shift position in which an operator of the host vehicle manually changes a gear ratio of a transmission of the host vehicle.
